(19) United States
(12) Patent Application Publication
(10) Pub. No.: US 2004/0158284 A1
(43) Pub. Date: Aug. 12, 2004

(54) Medical controller for segmental spinal cord reflex points

(76) Inventor: In-Soon Son, Gyeonggi-Do (KR)

Correspondence Address: ST. ONGE STEWARD JOHNSTON & REENS, LLC, 986 BEDFORD STREET, STAMFORD, CT, 06905-5619, US

(21) Appl. No.: 10/678,859

(22) Filed: Oct. 3, 2003

(30) Foreign Application Priority Data
Feb. 11, 2003 (KR) 2003-0008620

(51) Int. Cl. A61H 39/04

(52) U.S. Cl. 606/201; 606/204

(57) ABSTRACT

Disclosed is a medical controller for segmental spinal cord reflex points that has metal pressure protrusions formed in a horizontal linear arrangement in such a manner as to be clipped at the segmental spinal cord reflex points on the middle finger or the back of the hand for a certain time period, thus to control an excited signal transferred to the spinal cord reflex points from the cerebrum, so that various kinds of diseases can be prevented or cured well. The medical controller includes: a pair of finger grip parts having curved portions for surrounding a predetermined finger; a hinge part for hingeably coupling the pair of finger grip parts and provided with a spring that is adapted to elastically make the pair of finger grip parts closed, at the central portion thereof; and a pressure protrusion part disposed on the inner side of at least one of the pair of finger grip parts, the pressure protrusion part being made of a metal material and having concavo-convex surfaces, for applying predetermined metal stimulation to the segmental spinal cord reflex points under certain pressure.

This application claims priority of pending Korean Patent Application No. 2003-0008620, filed on Feb. 11, 2003.

### BACKGROUND OF THE INVENTION

1. Field of the Invention

The present invention relates to a medical controller that is capable of controlling a signal from the cerebrum acting as pathology at the segmental spinal cord reflex points, and more particularly, to a medical controller for segmental spinal cord reflex points that has metal pressure protrusions formed in a horizontal linear arrangement in such a manner as to be clipped at the segmental spinal cord reflex points on the middle finger or on the back of the hand for a predetermined time period, thus to control the excited signal (which will be explained later) transferred to the spinal cord reflex points from the cerebrum, so that various kinds of diseases can be prevented or cured well.

2. Background of the Related Art

All life processes of the human body are mechanically and biochemically maintained by the electrical signals that are transferred to the segments of the body from the cerebrum. Genetically, the human body has the central nerve system as a main one and also has the segmental nerves on the basis of the central nerve system, and therefore, all of the organs and the tissues of the human body are controlled by the segmental nerves (the spinal nerves). The nerve cells of the cerebrum are divided into the left brain and the right brain and they are distributed to the 31 pairs of segments through the 31 pairs of segmental nerves on the left and right brain, so that they control the sensation, motion and biochemical and physiological activities of the segmental system consisting of dermatome, myotome (skeletal muscle and smooth muscle), and sclerotome.

Life activities of the human body are achieved by maintaining the homoeostasis of the physiology via antagonism among three kinds of nerve systems (i.e., vagus nerve, sympathetic nerve, and parasympathetic nerve) in the left and right brain. The signals from the brain are decided at the time of birth, based upon the genetic factors, and the signals that are sent at present from the brain are formed by adding various environmental factors to the genetic factors. With the two factors, the nerve systems fail to keep their balance, such that a signal from one of the three kinds of nerve systems may stay at an excited state, which signal will be called ‘an excited signal’ in the preferred embodiments of this invention. The excited signal acts as the causes of all kinds of diseases. If the excited signal is controlled, therefore, the diseases are prevented or cured. It can be appreciated that the control of the excited signal means the treatment for diseases.

The nerve systems are generally in a network system. Especially, the segmental nerves of the upper and lower limbs of the human body are met with the nerve fibers from the segments of the upper and lower limbs or separated again therefrom in a repeated manner, when they leave the spinal cords, thereby forming a spinal nerve plexus. In the nerve-anatomical and physiological respects, it can be noted that the control for the signals causing all diseases is achieved at the segmental spinal cords or at the segmental spinal cord reflex points, in a safe and satisfying manner.

By the way, the area of the cortex of the cerebrum occupying in the face and hands of the human body is several tens of times as large as the other parts of the human body. Therefore, if the segmental spinal cord reflex points are found on the hands that functionally corresponds to the human body so as to be utilized, the control for the signals can be more effectively achieved.

Based upon the above-mentioned statement, the medical controller of this invention is embodied by applying metal stimulation to the segmental spinal cord reflex points on the middle finger and on the back of the hand corresponding to the central nerve system. The metal stimulation acts as the suppression against the segmental impulse, so that it removes the pathology of the segment that is caused by the excited impulse, thereby curing all of the symptoms and diseases for the corresponding pathology.

With the improvement of the existing “acupuncture therapy” that applies metal stimulation that is made through skin to muscle to thereby control the signals sent from the cerebrum, the medical controller of this invention is capable of controlling the signals from the cerebrum only with the metal stimulation applied to the skin corresponding to the segmental spinal cord reflex points, thereby allowing the diseases caused from the signals to be all cured and prevented. Therefore, it can remove the pain and danger that are accompanied by the existing acupuncture therapy, and moreover, only if the treatment points on the middle finger or the back of the hand are recognized, every people can easily carry out the treatment. This can prevent the diseases that may be taken at any time.

Many people under a variety of environmental stresses suffers from various diseases of adult people and diseases hard to cure, which causes various kinds of motion and sensation troubles that do not find the origins and names of the diseases. This of course results in the failure of the treatment for the diseases.

With the medical controller of this invention, however, all kinds of diseases are cured irrespective of their kinds or symptoms. That is to say, as the medical controller is usually embodied, it previously controls the excited signal as the factors of the pathology, which enables all kinds of diseases to be prevented.

The medical controller of this invention exhibits excellent treatment capabilities for all kinds of diseases, and more particularly, when it is of a ring type that is embodied on the middle finger, it shows most excellent treatment effect for heart and lung diseases and brain diseases.

Further, when the medical controller of this invention is of a clip type that is embodied at the segmental spinal cord reflex points on the back of the hand, it exhibits good treatment capabilities for the abdomen and the lower limbs. In more detail, a plurality of pressure protrusions, each of which is made of a metal material and is attached on the medical controller, apply depressing stimulation to 31 control points, i.e. segmental spinal cord reflex points that are disposed on the middle fingers and on the backs of the hands, such that the signals from the cerebrum are controlled to thereby cure and prevent the diseases due to the signals. The ring type controller with the elasticity of a spring is closely inserted into the middle finger of the hand, and the clip type controller is closely inserted in such a manner as to be placed on the back of the hand. With the elasticity of the clip type of controller, the plurality of pressure protrusions apply a predetermined pressure against the back of the hand. Such the medical controllers help the mechanical and biochemical and physiological activities substantially to be substantially recovered. Acupuncture therapy is one of oriental medical treatments that have been implemented for a substantially great long period of time, which is composed of the treatment on meridian points of the human body suitable for acupuncture, the treatment on the hands suitable for acupuncture, and the treatment on the hands and feet suitable for acupuncture. However, the present inventor has studied the actions of meridian system for 20 years and has finally found that they are related to nerve physiology. So, he has proved that the meridian theory shows the utilization of the nerve system that indicates the segmental physiology for the nerve system. However, since the study of anatomy didn't exist at that time, there occurred much confusion in the utilization of the nerve system.

The present inventor has related the statistics contained in the meridian theory to the nerve physiology found out anatomically and physiologically, and she has found through a number of experiments that the nerve system is a subject for the life processes of the human body and the electrical signals from the nerve system are controlled when they've got the metal stimulation.

So, the present inventor has revealed that the control for the electrical signals from the nerve system allows all kinds of diseases including ones hard to cure and ones that have not known their names or reasons to be well cured and prevented, without any generation of ill effects of the treatment. She has called it SON's Segmental Nerve Control (which is referred to as SNC) treatment. A segment consists of dermatome, myotome (skeletal muscle and smooth muscle), and sclerotome, which are under the control of the same nerves. That is to say, the nerves on the skin, ones on the skeletal muscle, ones on the smooth muscle in the organs, and ones on the vertebra are all the same nerves as one another. Conventional “magnetic acupuncture” therapy that has applied metal stimulation to the skeletal muscle to thereby make the signals changed, so as to achieve its treatment effect, shows the theory that the signals on the nerve fibers occupied on the skin can be controlled by the same metal stimulation. Based upon the aforementioned statement, the medical controller of this invention is embodied at the segmental spinal cord reflex points on the middle finger and on the back of the hand, such that it exhibits an excellent treatment effect in a wide range of diseases such as headaches, cerebral blood vessel diseases, otorhinolaryngology diseases, alimentary diseases, cardiac diseases, lung diseases, immunity diseases, intestinal diseases, uterine diseases, urinary diseases, motor disturbance diseases (backaches, arthralgia, and neuralgia), and so on.

The medical controller of this invention has a ring type, a clip type, and a band type, each of which is applied at the segmental spinal cord reflex points on the middle finger and on the back of the hand for 20 to 30 minutes or for 1 to 2 hours. The existing acupuncture therapy is hard to be carried out once or more a day. However, the medical controller of this invention can be freely used without any limitation in its use frequency.

As noted above, all diseases are caused by the excited signal sent from the cerebrum to the segmental nerves. From the viewpoint of the western medicine, however, they are caused by infection (bacteria or virus), hereditary, endocrine disorders, nervousness (mental diseases like stresses), and the like.

All life processes are maintained by the repetition of movements (voluntary and involuntary movements) in the inside and outside of the human body. The electromotive force of the movement looks very complicated but it is caused by the segmental muscles that are expanded and contracted by the electrical signals sent from the cerebrum to the segments. Therefore, the unit of movement is the segmental muscle. To achieve optimal life activities, the segmental muscles should be smoothly expanded and contracted. This is allowed only if the electrical signals from the cerebrum and the segments are balanced. If their balance is broken, the nerve system sends an excited signal that acts as the disease factors. At that time, the medical controller of this invention can control the excited signal by the metal stimulation to thereby recover the balance of the electrical signals. Therefore, it can be understood that the control of the electrical signals from the nerve system is most necessary and fundamental in curing and preventing diseases.

Furthermore, all diseases are accompanied with retrogression in the treatment. This is because the medicine fails to change the signals from the cerebrum. However, the medical controller of this invention can make the signal from the cerebrum substantially controlled, so that it can prevent the generation of the retrogression and achieve the regeneration of the retrogressive tissues.

### SUMMARY OF THE INVENTION

Accordingly, the present invention is directed to a medical controller for segmental spinal cord reflex points that substantially obviates one or more problems due to limitations and disadvantages of the related art.

An object of the present invention is to provide a medical controller for segmental spinal cord reflex points that is capable of controlling the signals from the cerebrum acting as pathology at the segmental spinal cord reflex points on the middle finger or on the back of the hand, so that various kinds of diseases can be prevented or cured well.

To achieve the above object, according to the present invention, there is provided a medical controller for segmental spinal cord reflex points including: a pair of finger grip parts having curved portions for surrounding a predetermined finger; a hinge part for hingeably coupling the pair of finger grip parts and provided with a spring that is adapted to elastically make the pair of finger grip parts closed, at the central portion thereof; and a pressure protrusion part disposed on the inner side of at least one of the pair of finger grip parts, the pressure protrusion part being made of a metal material and having concavo-convex surfaces, for applying predetermined metal stimulation to the segmental spinal cord reflex points under certain pressure.

### BRIEF DESCRIPTION OF THE DRAWINGS

Further objects and advantages of the invention can be more fully understood from the following detailed description taken in conjunction with the accompanying drawings in which:

FIGS. 1a to 1c are perspective and side views showing various kinds of medical controller according to the present invention, wherein FIG. 1a shows a ring type control body, FIG. 1b shows a clip type control body, and FIG. 1c shows a band type control body;

FIG. 2 is a perspective view showing various kinds of pressure protrusion part embodied in the medical controller of the present invention;

FIGS. 3a to 3c are exemplary views showing the cases where the medical controller of the present invention is embodied on the middle finger or on the back of the hand; and

FIG. 4 is an exemplary view showing the segmental spinal cord reflex points on the middle finger.

### DETAILED DESCRIPTION OF PREFERRED EMBODIMENTS

Reference will now be made in detail to preferred embodiments of the present invention, examples of which are illustrated in the accompanying drawings.

A medical controller for segmental spinal cord reflex points according to the present invention is of a ring type control body that is adapted to be inserted into the middle finger, a clip type control body that is adapted to be fitted on the back of the hand, and a band type control body that is used for children. An explanation of the method of applying the medical controller of this invention to the predetermined place will be given in accordance with its type.

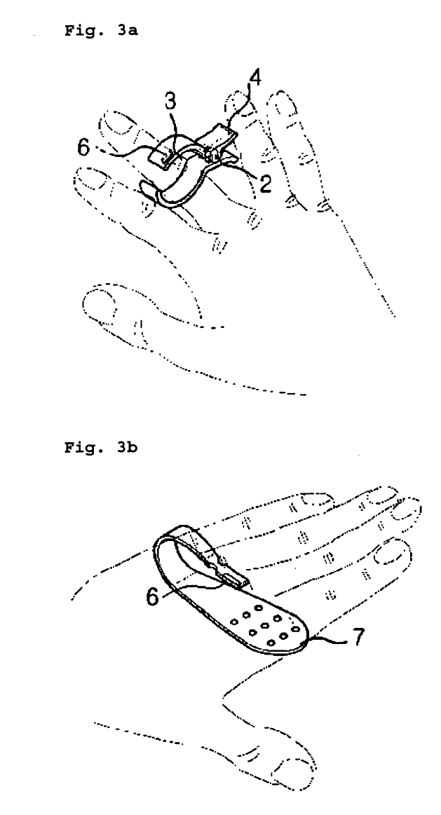

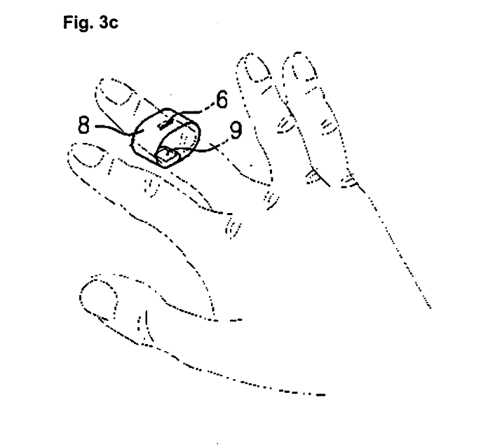

FIG. 3 illustrates the case where the medical controller of this invention is embodied at the segmental spinal cord reflex points on the middle finger. The ring type control body is configured in such a manner that a pair of finger grip parts 3 is adapted to surround the middle finger and a pressure protrusion part 6 is attached on the position adjacent by about 1 to 2 mm to the little finger from the central portion thereof. The ring type control body has driving handle grips 4 and a hinge part 2 installed between the handle grips 4 for hingeably coupling the pair of finger grip parts 3 to allow the pair of finger grip parts 3 be opened and closed. The hinge part 2 is provided with a spring 5 at the central portion thereof, so that the pair of finger grip parts 3 can press against the middle fingers by means of the spring 5.

The ring type control body is made of synthetic resin of a non-conductor, and takes a shape of general clamps. In the preferred embodiment of the present invention, it is of a ring type that is fitted to the diameter of the middle finger so as to be appropriately fitted around the finger. The present invention is characterized in that the metal pressure protrusion part 6 is fixedly installed on the inner side of one or more of the pair of finger grip parts 3.

The pressure protrusion part 6 is made of any one selected from the group consisting of gold, silver, platinum, copper, or an alloy thereof in a predetermined ratio and has a concavo-convex structure on outer distal ends of a straight line.

FIG. 2 shows the various types of pressure protrusion part 6 embodied in the medical controller of the present invention. The pressure protrusion part 6, which has a thickness of 0.7 mm and a length of 5 mm in a straight line, is embedded into and fixedly attached on the inner side of one or more of the pair of finger grip parts 3.

The pressure protrusion part 6 has various kinds of concavo-convex structure of which protrusions are pointed at the ends like a flat, toothed, conical or tripod shape, as shown in FIG. 2, which gives metal stimulation to the skin.

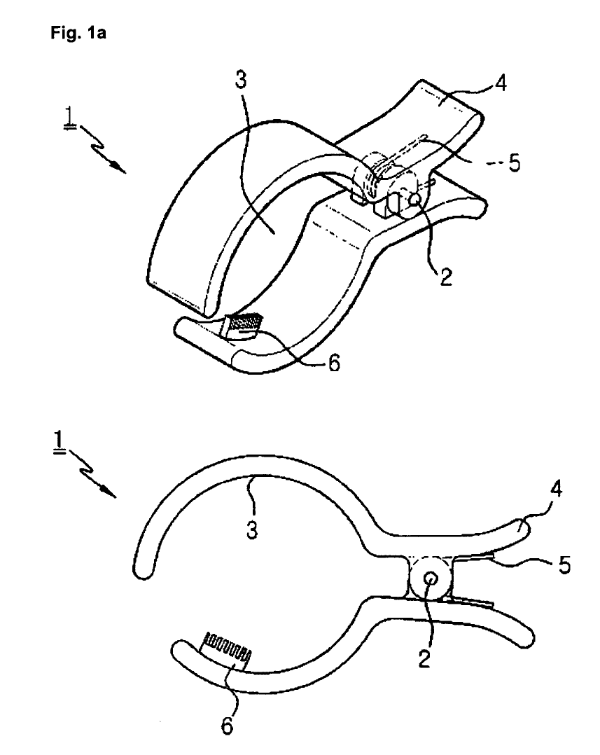

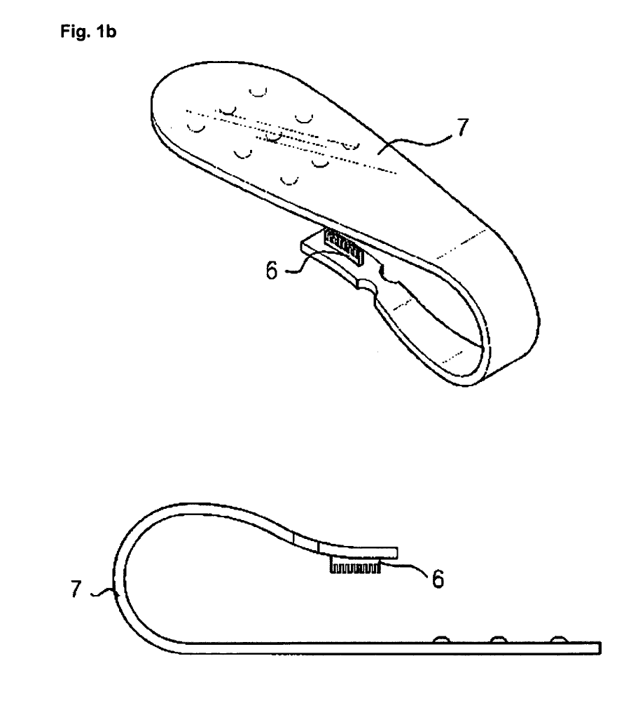

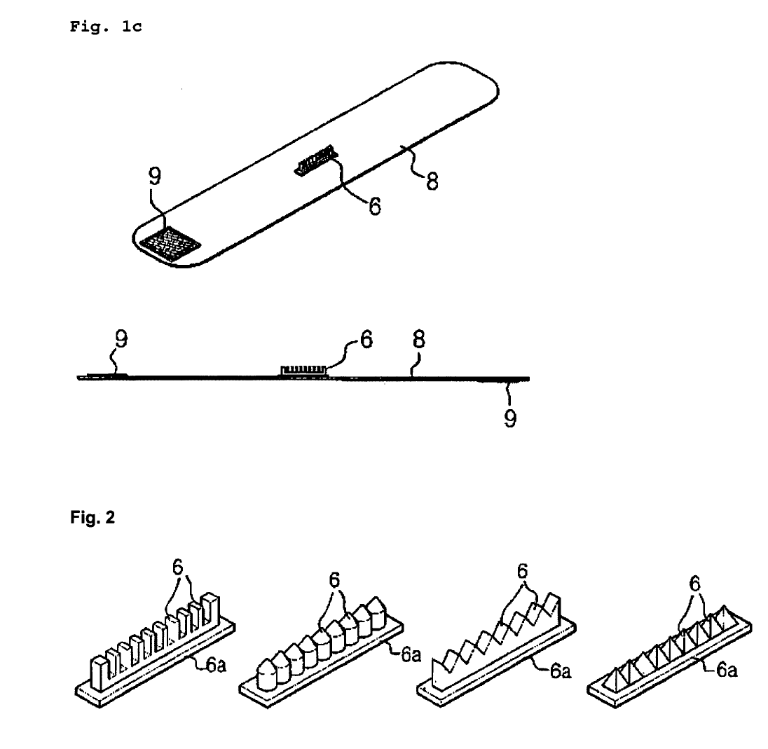

FIG. 1b shows the medical controller having the ring type control body 7 that is embodied at the segmental spinal cord reflex points on the back of the hand. The ring type control body 7 is made of an elastic synthetic resin, and bent at a predetermined position thereof, so as to be closely gripped on the segmental spinal cord reflex points on the back of the hand, by using the elasticity itself.

In the same manner as the ring type control body, the clip type control body has the pressure protrusion part 6 that has a length of about 7 mm in a straight line.

FIG. 1c shows the band type control body 8 made of a piece of cloth or vinyl that has the pressure protrusion part 6 attached thereon. In order to provide the same function as the clip type control body when the band type control body is positioned at or wound up on the middle finger or on the back of the hand or wound, there is provided a magic tape (Velcro fastener) 9 that is attached on the end portions of the inner and outer sides thereof.

FIGS. 3a to 3c show the embodiments of the medical controller of the present invention.

In case of using the ring type control body 1, the handle grips 4 are depressed to make the finger grip parts 3 open. Next, the finger grip parts 3 are fitted around the middle finger in such a manner that the pressure protrusion part 6 is correctly positioned at the segmental spinal cord reflex points on the middle finger.

In case of using the clip type control body 7, it is fitted around the hand in such a manner that the pressure protrusion part 6 is correctly positioned at the segmental spinal cord reflex points on the back of the hand.

In case of using the band type control body 8, it is wound in such a manner that the pressure protrusion part 6 is correctly positioned at the segmental spinal cord reflex points on the middle finger or on the back of the hand. Next, it is appropriately fixed by using the magic tape 9.

By using the aforementioned methods, the pressure protrusion part 6 is disposed at the segmental spinal cord reflex points on the middle finger or on the back of the hand, such that it gives a predetermined pressure to the reflex points, thereby achieving a desired treatment effect.

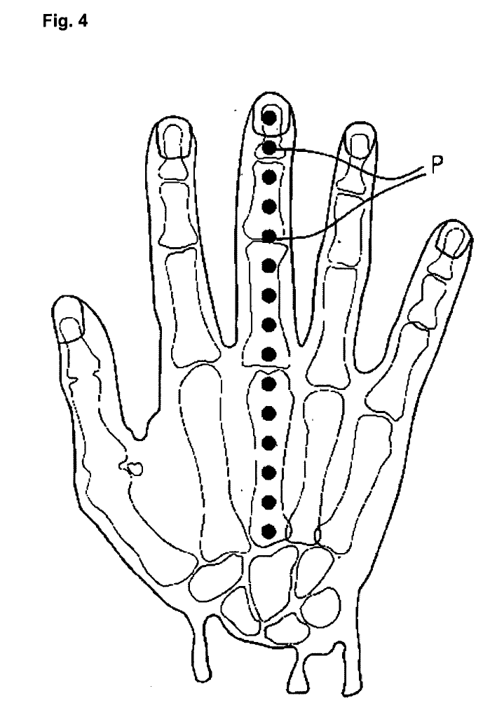

As shown in FIGS. 3a to 3c and 4, the medical controller of the present invention is closely gripped on the middle finger or on the back of the hand in such a manner that the pressure protrusion part 6 applies a predetermined pressure to the segmental spinal cord reflex points ‘p’ so that a user can feel a little pain as shown in FIG. 4.

As clearly set forth in the foregoing, the medical controller for the segmental spinal cord reflex points according to the present invention, that is applicable to the segmental nerve control (SNC) treatment developed by the present inventor, is capable of curing and preventing all kinds of diseases such as the diseases hard to cure, the diseases of which the names or reasons have not been known yet, and so on, which helps the health care of the human beings more improved than before.

What is claimed is:

1. A medical controller for segmental spinal cord reflex points comprising:
a pair of finger grip parts having curved portions for surrounding a predetermined finger;
a hinge part for hingeably coupling the pair of finger grip parts and provided with a spring that is adapted to elastically make the pair of finger grip parts closed, at the central portion thereof; and
a pressure protrusion part disposed on the inner side of at least one of the pair of finger grip parts, the pressure protrusion part being made of a metal material and having concavo-convex surfaces, for applying predetermined metal stimulation to the segmental spinal cord reflex points under certain pressure.

2. The medical controller according to 1, wherein the pressure protrusion part is made of any one selected from the group consisting of gold, silver, platinum, copper, or an alloy thereof.

3. The medical controller according to claim 1, wherein the pressure protrusion part has a height in a range between 2 mm and 7 mm and has the distal end portion of a flat, toothed, conical or tripod shape.

4. A medical controller for segmental spinal cord reflex points comprising:
a clip type body made of an elastic material, the clip type body being bent in such a manner as to grip the back of the hand; and
a pressure protrusion part disposed on the inner side of the body of the clip type, the pressure protrusion part being made of a metal material and having concavo-convex surfaces, for applying predetermined metal stimulation to the segmental spinal cord reflex points under certain pressure.

5. The medical controller according to 4, wherein the pressure protrusion part is made of any one selected from the group consisting of gold, silver, platinum, copper, or an alloy thereof.

6. The medical controller according to claim 4, wherein the pressure protrusion part has a height in a range between 2 mm and 7 mm and has the distal end portion of a flat, toothed, conical or tripod shape.

7. A medical controller for segmental spinal cord reflex points comprising:
a band type member made of a piece of cloth or a synthetic resin;
a fixing member for fixing the band type member such that the band type member is formed in a ring shape; and
a pressure protrusion part disposed on one side of the band type member, the pressure protrusion part being made of a metal material and having concavo-convex surfaces, for applying predetermined metal stimulation to the segmental spinal cord reflex points under certain pressure.

8. The medical controller according to 7, wherein the pressure protrusion part is made of any one selected from the group consisting of gold, silver, platinum, copper, or an alloy thereof.

9. The medical controller according to claim 7, wherein the pressure protrusion part has a height in a range between 2 mm and 7 mm and has the distal end portion of a flat, toothed, conical or tripod shape.
